(19) United States
(12) Patent Application Publication
(10) Pub. No.: US 2026/0285021 A1
(43) Pub. Date: Sep. 24, 2026

(54) TRANSFERABLE FILM-BASED STRUCTURED SUBSTRATES

(71) Applicant: 3M INNOVATIVE PROPERTIES COMPANY, St. Paul, MN (US)

(72) Inventors: Kayla C. Picha, Maplewood, MN (US); Brylee David B. Tiu, Falcon Heights, MN (US); Joshua M. Fishman, Saint Louis Park, MN (US); Karl K. Stensvad, Eagan, MN (US); Derek W. Patzman, Prior Lake, MN (US); Kevin W. Gotrik, Hudson, WI (US)

(21) Appl. No.: 19/477,426

(22) PCT Filed: Apr. 19, 2024
(86) PCT No.: PCT/IB2024/053858

§ 371 Date: Oct. 21, 2025

Related U.S. Application Data
(60) Provisional application No. 63/502,277, filed on May 15, 2023.

(51) Int. Cl. B32B 37/00; B32B 3/30; B32B 7/06; B32B 7/12; B32B 17/10; B32B 27/08

(52) U.S. Cl. CPC B32B 37/025; B32B 3/30; B32B 7/06; B32B 7/12; B32B 17/10; B32B 27/08; B32B 2250/05; B32B 2307/7166; B32B 2307/7376; B32B 2307/748

(57) ABSTRACT

Transferable nanopattemed substrates are described. These substrates include a transfer carrier laminated to the structured surface of a multilayer construction. After transferring the construction, the transfer carrier can be removed without damaging the structured layer. Methods of making such transferrable nanopattemed substrates are also described.

### FIELD

The present disclosure relates to film-based structured substrates. The design and structure of the structured substrates allow them to be transferred to a rigid substrate such as glass. Methods of making such transferable film-based structured substrates are also described.

### SUMMARY

Briefly, in one aspect, the present disclosure provides an article comprising a skin layer having a first major skin surface and a second major skin surface; a structured substrate having a planar major surface adjacent the second major skin surface and a structured surface comprising a projected surface and a recessed surface; wherein the structured substrate comprises an antibiofouling layer, an inorganic layer and a masking layer; and a transfer carrier comprising a lamination layer having a first lamination surface bonded to the projected surface and the recessed surface.

In another aspect, the present disclosure provides a method comprising, on a support structure comprising a support layer and skin layer having a first major skin surface bonded to the support, creating a structured substrate having a planar major surface bonded to a second major skin surface of the skin layer and a structured surface comprising a projected surface, a recessed surface, and a side surface connecting the projected surface and the recessed surfaces, wherein the structured substrate comprises an antibiofouling layer, an inorganic layer and a masking layer; bonding a transfer carrier comprising a lamination layer to the projected surface and the recessed surface, wherein the lamination is bonded to the masking layer; and separating the skin layer from the support layer, wherein the transfer carrier and structured substrate remain bonded to the skin layer forming a transferable structured substrate.

### BRIEF DESCRIPTION OF THE DRAWINGS

FIG. 1 illustrates a structured substrate comprising projections.

FIG. 2 illustrates a structured substrate comprising wells.

FIG. 3 illustrates a transferable structured substrate with a carrier.

FIG. 4 illustrates a transferable structured substrate with the support removed.

FIG. 5 illustrates a transferable structured substrate with an adhesive and optional liner.

FIG. 6 illustrates a transferable structured substrate bonded to a rigid substrate.

FIG. 7 illustrates a structured substrate comprising projections bonded to a rigid substrate with the carrier removed.

FIG. 8 illustrates a structured substrate comprising wells bonded to a rigid substrate with the carrier removed.

### DETAILED DESCRIPTION

The cost of gene sequencing is driven by the single-use consumables needed to run sequencing instruments. The consumables for each sequencing run are the chemical and biochemical reagents used to probe the unknown sample and the flow cell where the sequencing reactions take place. Typically, these flow cells have contained glass or silicon substrates with 250-2000 nanometer (nm) nanowells etched into them. The wells are then filled with a hydrogel having a chemistry selected to bind target DNA samples.

Some gene sequencers use fluorescent imaging as their detection method and the nanowells allow individual samples (i.e., unique clusters of DNA amplicons in each well) to be packed as close as possible while remaining optically resolvable. Therefore, the patterning of the hydrogel functionalized nanowells is necessary to achieve a high per run throughput as compared to flow cells where the clusters of DNA amplicons are randomly seeded.

Currently, these nanopatterned substrates are manufactured using a wafer-based photolithographic approach that contains many process steps performed in batch processes to generate nanowells that are selectively functionalized with chemistry that enables filling the wells with hydrogel and depositing an anti-biofouling coating between the wells including vapor deposition, masking, etching, mask-removal, chemical-mechanical planarization (CMP), spin coating and washing steps. As a result, the manufacturing cost of just these patterned substrates is estimated to be thousands of dollars per part and is a main driver for overall sequencing kit costs.

International Patent Publication Numbers WO 2022/058845 A1 and WO 2022/144626 describe nanopatterned substrates for use in chemical or biological assays that are formed on flexible carrier films. The carriers can be relatively thick, e.g., greater than 15 microns thick, to provide the desired mechanical stability for forming and processing the nanostructures in roll-to-roll processes. Such films have been bonded to rigid substrates such as glass and silicon. However, due in part to the thickness of the carrier films used, the autofluorescence of the carrier can interfere with the fluorescent imaging and detection of the gene sequencer. In addition, the thickness variation across the substrate might require a change in focal plane of the imaging equipment as it scans across flow cells with large surface areas.

There remains a need to provide robust processes to produce film-based nanopatterned substrates, particularly cost-effective roll-to-roll processes. In addition, there is a need to provide film-based nanopatterned substrates that reduce or eliminate concerns with autofluorescence, thickness uniformity or flatness. There is also a need to provide processes and structures capable of being handled throughout manufacturing and use without damaging the nanopatterned features.

The methods of the present disclosure begin with a support comprising a flexible support layer and a peelable skin layer releasably bonded to the support layer. In prior art methods, transparent, non-auto-fluorescing substrates were required. In the present disclosure, the support layer is removed prior to use and these limitations are not required; therefore, a broad range of substrates may be used. Exemplary support layers include paper, metal foils, polymeric films, and combinations thereof. Suitable polymeric films include, e.g., polyesters, poly(meth)acrylates, polyamides, polycarbonates, polyolefins, cyclic olefin polymers (COPs), cyclic olefin copolymers (COCs), poly(meth)acrylates, polyethylene naphtholate (PEN), polyether ether ketone (PEEK), polyimide, polypropylene, polyethylene, high molecular weight fluorinated polymers such as THV or PVDF, and silicones. Provided the structure remains flexible, the thickness of the support layer is not critical as it will be removed and will not contribute to any undesirable autofluorescence.

The skin layer is releasably bonded to the support layer. The adhesion force between the skin layer and the support layer should be low enough to allow the skin layer to be peeled cleanly from the support layer without damaging the skin layer or distorting the structures built on the skin layer, i.e., the skin layer is a peelable skin layer. In some cases, a peel force between the skin layer and the support layer is no greater than 25 g/cm, e.g., no greater than 20, no greater than 15, or even no greater than 10 g/cm. In some cases, the peel force is at least 0.5 g/cm, e.g., at least 1, at least 2, or even at least 5 g/cm. For example, in some cases, a peel force is from 0.5 to 25 g/cm, e.g., 1 to 20, 2 to 15, or 2 to 10 g/cm, inclusive. The peel force may be determined by standard test methods including 90- or 180-degree peel tests. The surface of the support layer may be treated using known materials and processes to obtain the desired peel force.

As the skin layer remains part of the article in use, thinner layers of non- or low-auto-fluorescing materials are preferred. The skin layers can be thermoplastics or thermosets. Examples of suitable peelable skin layers include those comprising polyesters, poly(meth)acrylates, polyamides, polycarbonates, polyolefins (e.g., polyethylenes and polypropylenes), cyclic olefin polymers (COPs), cyclic olefin copolymers (COCs), polyurethanes, high molecular weight fluorinated polymers such as THV or PVDF, and silicones.

Although thicker skin layers may be used, in the present invention thin skin layers may be used because the support layer provides the desired mechanical strength and stability during processing. In some cases, the skin layer may be no greater than 15 microns thick, e.g., no greater than 10 microns, no greater than 5 microns, no greater than 2 microns, or even no greater than 1500 nm thick. In some cases, the skin layer is at least 10 nm thick, e.g., at least 20 or even at least 50 nanometers thick. In some cases, the skin layer is from 5 nm to 15 microns thick, e.g., 50 nm to 2 microns, 50 to 1500 nm, or even 50 to 800 nm thick, inclusive.

Support layers with peelable skin layers may be prepared according to known methods including coating and deposition (e.g., sputtering or vapor deposition). For example, the methods of U.S. Provisional Patent Appl. 63/265,650 (“Planarized Inorganic Thin Film Transfer Article,” Gotrick et al.) or U.S. Patent Publication 2020/0156355 A1 (“Multi-Layer Isotropic Films Having Toughness, High Temperature Performance, and UV Absorption,” Johnson et al.) may be used.

Functionalized structures (e.g., microstructures, nanostructures or both) are built on the skin layer of the support. Known methods of creating such structures may be used. For example, the methods of International Patent Publication WO 2022/144626 A1 (“Nanopatterned Films with Patterned Surface Chemistry,” Van Lengerich et al.) and International Patent Publication WO 2022/058845 A1 (“Nanopatterned Films with Patterned Surface Chemistry,” Fishman et al.) may be used to create a structured substrate comprising elevated posts surrounded by recessed land areas or recessed wells relative to an elevated land area.

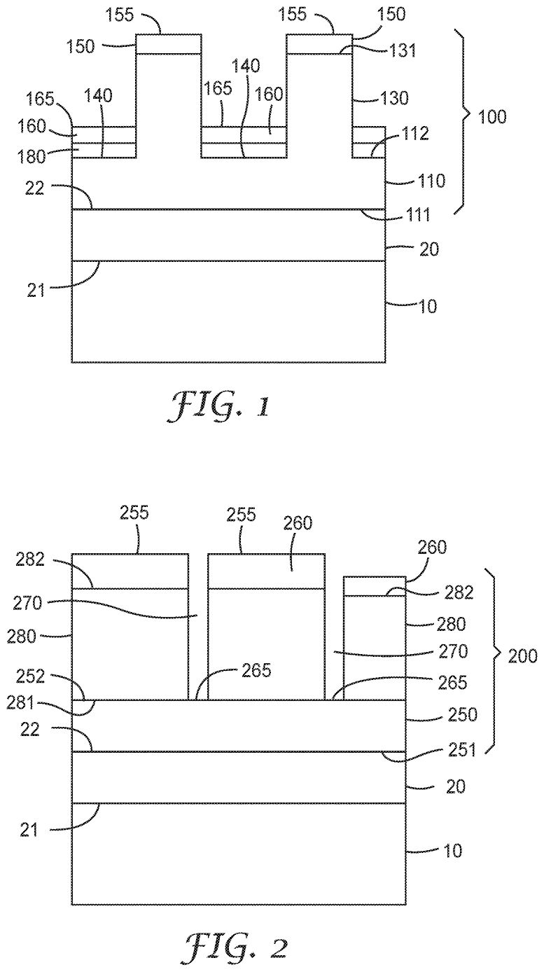

For example, referring to FIG. 1, structured substrate 100 comprises resin layer 110 having first major resin surface 111 bonded to second major skin surface 22 of skin layer 20. Skin layer 20 is a peelable skin layer having first major skin surface 21 releasably bonded to support layer 10. Resin layer 110 includes a plurality of projections 130 extending from second major resin surface 112, wherein each projection terminates in a distal end 131 and is separated from adjacent projections by land areas 140 of second major resin surface 112, which are recessed relative to the distal ends 131 of the projections 130.

Antibiofouling layer 180 is bonded to second major resin surface 112 in land areas 140. Masking layer 160 is bonded to antibiofouling layer 180 with the exposed surfaces of the masking layer collectively forming recessed surface 165. In some cases, the antibiofouling layer may cover a portion of the walls of the projections extending from second major resin surface 112 up to the height of the recessed surface. If present, this portion of the antibiofouling layer would be located between masking layer 160 and the side wall of the projection. Inorganic layer 150 is bonded to distal ends 131 of projections 130 with the exposed surfaces of the inorganic layer collectively forming projected surface 155. In some cases, the inorganic layer may cover portions of the walls of the projections extending between the distal ends of the projections and the recessed surface.

One or more additional layers may be included in structured substrate 100. For example, an additional layer may be present at one or more locations including between the skin layer and the resin layer, between the resin layer and the inorganic layer, between the resin layer and the masking layer, on the inorganic layer, and on the masking layer. If one or more additional layers are provided on inorganic layer 150, the exposed surfaces of the outermost layers at distal ends 131 of projections 130 will collectively form projected surface 155. Similarly, if one or more additional layers are provided on masking layer 160, the exposed surfaces of the outermost layers in land areas 140 will collectively form recessed surface 165.

Alternatively, referring to FIG. 2, structured substrate 200 comprises inorganic layer 250 having first major inorganic surface 251 bonded to second major skin surface 22 of skin layer 20. Again, skin layer 20 is a peelable skin layer having first major skin surface 21 releasably bonded to support layer 10. Antibiofouling layer 280 has first major antibiofouling surface 281 and second major antibiofouling surface 282. First major antibiofouling surface 281 is bonded to second major inorganic surface 252 of inorganic layer 250.

Antibiofouling layer 280 includes a plurality of wells 270 extending from second major antibiofouling surface 212 through a thickness of the antibiofouling layer. Each well 270 terminates in an exposed portion of second major inorganic surface 252 of the inorganic layer, wherein the exposed surfaces of inorganic layer collectively form recessed surface 265. Masking layer 260 is bonded to second major antibiofouling surface 282 in the areas surrounding wells 270 with the exposed surfaces of the masking layer collectively forming projected surface 255.

One or more additional layers may be included in structured substrate 200. For example, an additional layer may be present at one or more locations including between the skin layer and the inorganic layer, between the antibiofouling layer and the inorganic layer, between the antibiofouling layer and the masking layer, on the inorganic layer, and on the masking layer. If one or more additional layers are provided on inorganic layer 250, the exposed surfaces of the outermost layer at the base of wells 270 will collectively form recessed surface 265. Similarly, if one or more additional layers are provided on masking layer 260, the exposed surface of the outermost layer in the areas surrounding wells 270 will collectively form projected surface 255.

As used herein, the terms “projected surface” and “recessed surface” refer to the relative positions of the exposed surfaces of a structured surface layer. Thus, in the case of projections (e.g., posts) surrounded by land areas, the exposed distal ends of the posts are projected surfaces relative to the recessed exposed land areas between the posts. That is, the distal ends of the posts are further from the skin layer than the land areas. Similarly, in the case of wells, the exposed base of the wells are recessed surfaces relative to the projected surface of the resin layer surrounding the wells, sometimes referred to as the land area.

As used herein, the term “bonded” when referring to a first layer bonded to a second layer includes both direct bonding and indirect bonding. A first layer is directly bonded to a second layer if the surfaces of the first layer and second layer are in direct contact. A first layer is indirectly bonded to a second layer if the surfaces of the first layer and second layer are separated by one or more intermediate layers connecting their surfaces. For example, a first layer may be indirectly bonded to a second layer by an intermediate layer such as an adhesive layer.

In some cases, the structures are nanostructures. For example, in some cases one or more of the diameter, height and spacing between the projections is from 5 to 5000 nanometers, e.g., 5 to 1500, 10 to 1500, 50 to 1000 nm, or even 50 to 500 nm. In some cases, one or more of the diameter, the depth and the spacing between the wells is from 5 to 5000 nanometers, e.g., 5 to 1500, 10 to 1500, 50 to 1000 nm, or even 50 to 500 nm.

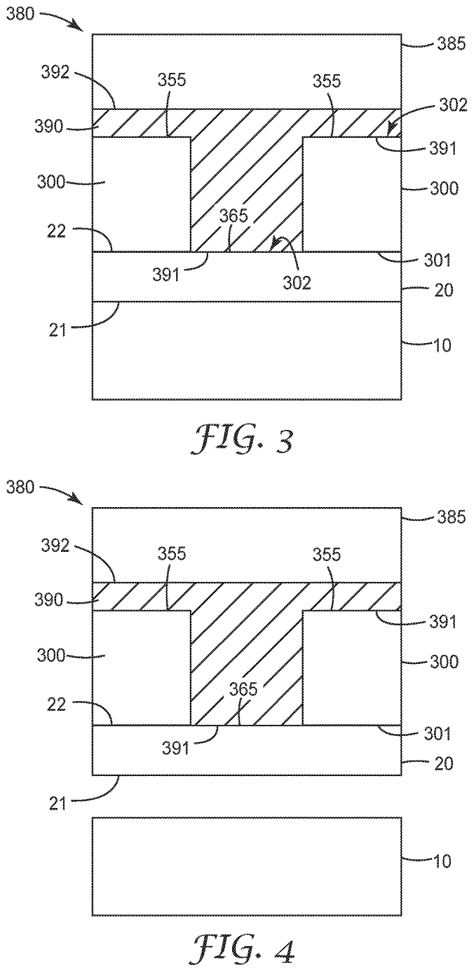

In another step, a transfer carrier is bonded to the exposed surfaces of the structured substrate by a lamination layer. Referring to FIG. 3, structured substrate 300 includes a major surface 301 bonded (directly or indirectly) to second major skin surface 22 of skin layer 20. First major skin surface 21 is bonded to support layer 10. Structured substrate 300 also includes structured surface 302 comprising projected surface 355 and recessed surface 365.

Transfer carrier 380 comprises carrier layer 385 and lamination layer 390 having first lamination surface 391 bonded to structured surface 302 including both projected surface 355 and recessed surface 365. Second lamination surface 392 of lamination layer 390 is bonded to carrier layer 385 of transfer carrier 380.

As the transfer layer and lamination layer will be removed prior to use, a wide variety of materials may be used. Suitable transfer layers include, e.g., polymeric films (including polyesters, polyolefins, polystyrene, and nylons), metal foils, and combinations thereof. Suitable lamination layers include adhesives such as hot-melt adhesives and pressure sensitive adhesives. Exemplary lamination layers may comprise thermoplastics and acrylates.

The lamination layer should be selected such that it bonds to the outermost surface of both the elevated and recessed surfaces of the structured surface yet be capable of being removed from these surfaces without damaging the desired structured surface. For example, in some cases, the maximum peel force between the lamination layer and the structured substrate is no greater than 25 g/cm, e.g., no greater than 20, no greater than 15, or even no greater than 10 g/cm. In some cases, the minimum peel force between the lamination layer and the structured substrate is at least 0.5 g/cm, e.g., at least 1, at least 2, or even at least 5 g/cm. For example, in some cases, the peel force is from 0.5 to 25 g/cm, e.g., 1 to 20, 2 to 15, or 2 to 10 g/cm, inclusive. The peel force may be determined by standard test methods including 90- or 180-degree peel tests.

Referring to FIG. 4, in a subsequent step, transfer carrier 380 may be used to separate skin layer 20 from support layer 10. By controlling the peel force between the skin layer and support layer, the skin layer can be removed from the support layer without damaging the skin layer and without distorting structured substrate 300, which remains bonded to lamination layer 390, supported by carrier layer 385.

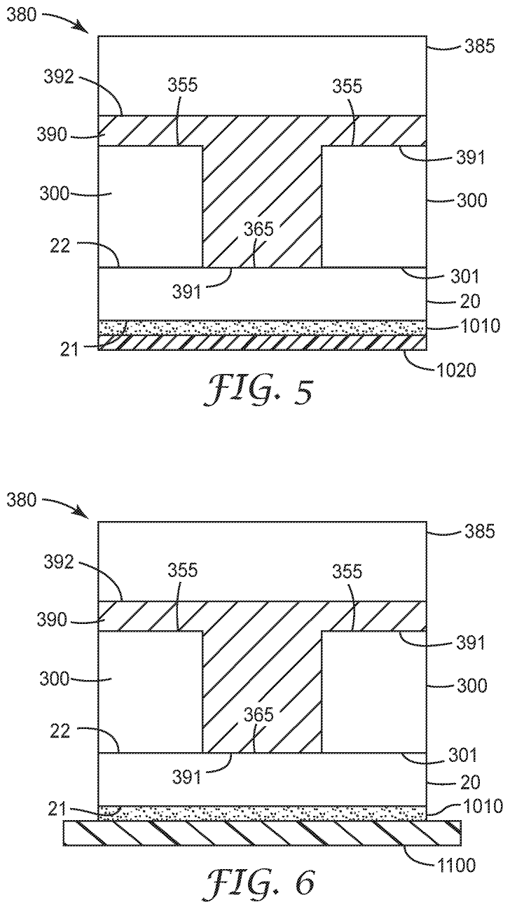

Referring to FIG. 5, in some cases, adhesive layer 1010 may be bonded to first surface 21 of skin layer 20. Optionally, release liner 1020 may be bonded to adhesive layer 1010. Referring to FIG. 6, adhesive layer 1010 may be used to bond structured substrate 300 to support 1100, after removing release liner 1020, if present. Alternatively, adhesive layer 1010 may be applied to support 1100. Subsequently, first surface 21 of skin layer 20 may be bonded adhesive layer 1010 resulting in structured substrate 300 being bonded to support 1100.

The support is typically a rigid substrate. Exemplary substrates include glass and silicon substrates. Exemplary adhesives include hot-melt and pressure sensitive adhesives. The adhesive layer is typically optically clear and low- or non-auto-fluorescing. Suitable adhesives include block copolymers, polyisobutylene, acrylates and methacrylates adhesives, polyamides, polyurethanes, and silicones. In some cases, optically clear adhesives, including those available from 3M Company, may be preferred. Thin adhesive layers may be preferred. In some cases, the adhesive layer is no greater than 1000 nm, e.g., no greater than 500 or no greater than 200 nm thick. In some cases, the adhesive layer is from 5 to 1000 nm, e.g., 5 to 500, or even 10 to 200 nm thick.

After lamination to the support, e.g., the rigid substrate, the transfer carrier may be removed exposing the structured substrate. The materials used or the lamination layer and the exposed surfaces of both the projected surface and recessed surface may be selected to allow clean removal of the lamination layer with minimal or no distortion of the structured substrate including the masking layer. However, this may require additional processing steps such as washing with an appropriate solvent (e.g., water) if removal of the masking layer is also desired. Therefore, it may be desirable to select materials that allow the masking layer to be removed with the transfer carrier. For example, the materials may be selected such that the bond strength between the lamination layer and the masking layer is greater than the bond strength between the masking layer and its immediately underlying substrate at e.g., the recessed land areas between posts, or the projected surface surrounding wells. With such selections, the masking layer can be removed with the carrier film exposing the structured layer. If the masking layer is not completely removed, any residual material may be removed by, e.g., washing with an appropriate solvent (e.g., water).

Masking layer. The masking layer is a removable layer, e.g., a washable/peelable material, that can be applied anywhere throughout the nanopattern. In some cases, the material can be cured. Suitable materials include polyvinyl alcohol (PVA), polyvinyl butyral (PVB), polyacrylamide and its copolymers, poly(hydroxyethylmethacrylate) and copolymers, as well as other water-soluble polymers. The masking layer protects the regions underlying it during various process steps. The masking layer is then removed after exposure to those conditions, to reveal the underlying materials. In some cases, masking layers can minimize or eliminate the impact of plasma treatments on underlying protected areas.

Resin layer. The resin layer is any polymeric material, preferably one suitable or amenable for use in a roll-to-roll process. Preferably, it should have low autofluorescence to provide a low-noise background. In some examples, to provide low autofluorescence to detect a wide variety of biological detection molecules, cyclic olefin copolymers (COP) or biaxially oriented polypropylene (BOPP), which each have low autofluorescence across a wide spectrum, can be used. Other examples of suitable low autofluorescent polymeric materials include, but are not limited to, poly(meth)acrylates and copolymers thereof, wherein (meth)acrylates include acrylates and methacrylates, polyamides, polyesters, polycarbonates such as, for example, those available under the trade designation MAKROLON from Covestro AG, Pittsburgh, PA, hydrogenated styrenics such as, for example, cyclic block copolymers available from Vivion, Inc., San Carlos, CA, and mixtures and combinations thereof. In some cases, the (meth)acrylates may be curable with ultraviolet (UV) radiation.

Antibiofouling layer. The antibiofouling layer is a hydrophobic, non-reactive layer that resists or prevents accumulation or formation of biological species such as, for example, microorganisms, or biomolecules such as nucleic acids and proteins. These materials are resistant to non-specific binding of target analyte and other reagents used in sequencing, chemically resistant to silanes, and etchable to enable patterning. The exposed surface of the anti-biofouling layer prevents target analytes, sequencing reagents or fluorophores from non-specific adsorption. In one example, which is not intended to be limiting, methyl groups are formed through plasma enhanced chemical vapor deposition (PECVD) of hexamethyldisiloxane, which forms a thin surface having a thickness of about 1 nm to about 10 nm, or about 2 nm to about 8 nm. In some examples, a methyl-terminated surface of the anti-biofouling layer is sufficiently rich in methyl groups to provide a water contact angle greater than 100 degrees.

In some examples, methyl groups can be formed from molecular fragmentation of hexamethyldisiloxane through plasma dissociation, although any method of creating a methyl-terminated surface on a metal, metalloid, metal oxide, or metalloid oxide may provide similar functionality.

Another example of forming an anti-biofouling surface on an inorganic layer includes reaction of silanes with a hydrolytically sensitive center having an organic substitution that contains a methyl group. Examples of hydrolytic reactive groups are chloro, methoxy, ethoxy, propoxy, methoxyalkoxy, acetoxy, and amines such as, for example, dimethylamine, silazane, or oxime. Examples of organic substitutions include methyl, linear alkyl, branched alkyl, aryl, and dipodal. In various examples, silanes can be applied by vapor phase deposition, spray, or solvent coating. Other chemistries such as tetraethyl orthosilicate, tetramethylsilane, hexamethyldisilane, bis(trimethylsilyl)amine, trimethylamine, tetramethyltin, and other analogous metal alkyl compounds may be deposited using plasma enhanced chemical vapor deposition to create methyl terminated surfaces. In addition, precursors such as trimethylamine may form a monolayer of methyl groups on an appropriate surface using atomic layer deposition. In addition, antibiofouling materials can also include building blocks composed of thermoplastics such as fluoropolymers, polyolefins, polyesters, silicones, polyacrylates with long linear alkyl chains that can crystalize (e.g., C18), and silicon (meth)acrylates.

Inorganic layer. Inorganic layers comprise a metal, metalloid, metal oxide or a metalloid oxide. Vapor-depositable materials amenable to functionalization with adhesion promotor that can be used to grow or conjugate DNA binding media may be used. In some cases, the inorganic layer has a thickness of less than about 200 nm, or less than about 100 nm, less than about 50 nm, or even less than about 20 nm. The composition of the inorganic layer may vary widely, but in some examples, which are not intended to be limiting, includes silicon oxides such as SiO₂, SiCxOy or SiAlxOy, as well as TiO, aluminum oxides such as AlOx, oxides of other metals such as Au, Sn, Ge, Ga, Zn, and In, and mixtures and combinations thereof. In contrast to traditional wafer processing, amorphous silicon oxide deposited by roll-to-roll processing may include impurities such as aluminum or carbon, which can make possible more efficient deposition rates on flexible, temperature sensitive surfaces using, for example, sputtering or PECVD technology.

### EXAMPLES

TABLE 1
Summary of materials used in the preparation of the examples.

| Name | Description |
|---|---|
| Kraton FG1901 | Adhesive used for laminating nanostructures on glass |
| | (Kraton Corporation, Houston, TX) |
| PVA | 9,000-10,000 mw polyvinyl alcohol |
| PVB | Mohwitol 30H Polyvinyl butyral |
| Coating | 4 wt. % PVB in IPA |
| Solution 1 | |
| Coating | 2.5 wt % PVA, 0.5 wt. % TERGITOL 15-7 in 60/40 |
| Solution 2 | H₂0/IPA |
| Acrylate | 75 wt % Photomer 6210 with 25 wt % SR238 and |
| Resin A | 0.5% TPO |
| Acrylate | 60% Photomer 6210, 20% SR238, 20% SR351, 0.5% |
| Resin B | TPO |
| PHOTOMER | Urethane acrylate oligomer PHOTOMER 6210; IGM |
| 6210 | Resins, Charlotte, NC |
| SR238 | 1,6-Hexandiol diacrylate; SR238 Sartomer Americas, |
| | Exton, PA |
| SR351 | Trimethylopropane triacrylate; SR351, Sartomer |
| | Americas |
| TPO | Diphenyl(2,4,6-trimethylbenzoyl)phosphine Oxide; |
| | IRGACURE TPO; BASF, Florham Park, NJ |
| Fluoropolymer | 3 wt % THV221A (3M Company, St. Paul, MN, |
| Solution 1 | United States) in a 80/20 solution of MEK/MIBK |
| MEK | Methyl ethyl ketone |
| MIBK | Methyl isobutyl |
| MELENEX 454 | Polyester film available under the trade designation |
| | MELENEX 454, Tekra, Inc. New Berlin, WI, |
| | United States |
| ST505 | Polyester film available under the trade designation |
| | MELENEX ST505, Tekra, Inc. New Berlin, WI, |
| | United States |

Autofluorescence Procedure. Samples were measured free standing in the front sample position (sample angled 30 degrees right of normal to incident and detector optics 10 degrees right of normal) on a Perkin Elmer Lambda 1050 spectrophotometer fitted with a PELA 1002 integrating sphere accessory. The scan speed was set to 102 nm/minute, the UV-Vis integration was set to 0.56 sec/pt, the data interval was set to 1 nm and the slit width was set to 5 nm. The instrument was set to “% Transmission” and “% Reflectance” mode.

For comparison to a known reference, a 10 ppm quinine solution in 0.5 N sulfuric acid was prepared from quinine hemisulfate monohydrate and presented in a 10 mm quartz cell.

### Example 1: Posts

Step 1 (making the skin layer): A support with a peelable skin layer was made according to the methods described in U.S. Patent Publication 2020/0156355 A1 (“Multi-Layer Isotropic Films Having Toughness, High Temperature Performance, and UV Absorption,” Johnson et al.). The support layer was a 50-micron thick PET film and the peelable skin was a 15-micron thick polyester terephthalate glycol (PETg) layer.

Step 2 (making the structured resin layer): A resin layer with a nano-featured structured surface was prepared by die coating Acrylate Resin B onto the peelable skin layer of the support formed in Step 1. The resin-coated skin layer was pressed against a nanostructured nickel surface attached to a steel roller controlled at 60° C. using a rubber covered roller at a speed of 15.2 meters/min. The nanostructured nickel tool consists of one 10 cm×10 cm patterned area with hole features approximately 1500 nm in diameter. The resin thickness was sufficient to fully wet the nickel surface and form a rolling bead of resin as the coated film was pressed against the nanostructured nickel surface. The resin layer was exposed to radiation from two Fusion UV lamp systems (obtained under the trade designation “F600” from Fusion UV Systems, Gaithersburg, MD) fitted with D bulbs both operating at 142 W/cm while in contact with the nanostructured nickel surface. After peeling the construction from the nanostructured nickel surface, the structured side of the resin layer was exposed again to radiation from the Fusion UV lamp system. The resulting post features were about 300 nm tall and had side wall angles of approximately 4 degrees.

Step 3 (forming the antibiofouling layer): A hexamethyldisiloxane (HMDSO) containing release film assembled according to methods described in U.S. Pat. No. 6,696,157 (David et al.) and U.S. Pat. No. 8,664,323 (Iyer et al.) and U.S. Patent Publication No. 2013/0229378 (Iyer et al.) was applied to the nano-feature-structured surface of the resin layer prepared in Step 2 in a parallel plate capacitively coupled plasma reactor. The reactor chamber had a central cylindrical powered electrode with a surface area of 1.7 square meters. After placing the nanostructured resin layer supported by the skin layer and support combined with the release film on the powered electrode, the reactor chamber was pumped down to a base pressure of less than 1.3 Pa. Oxygen gas was flowed into the chamber at a rate of 1000 SCCM. Treatment was carried out using a plasma enhanced CVD method by coupling RF power into the reactor at a frequency of 13.56 MHz and an applied power of 2000 watts. Treatment time was controlled by moving the nanostructured tooling film through the reaction zone at rate of 9.1 meter/min resulting in an approximate exposure time of 10 seconds. RF power was then turned off and gases were evacuated from the reactor.

Following this first treatment, a second plasma treatment was carried out in the same reactor without returning the chamber to atmospheric pressure. HMDSO gas was flowed into the chamber at approximately 1750 SCCM to achieve a pressure of 1.2 Pa. RF power (13.56 MHz) was subsequently coupled into the reactor with an applied power of 1000 W. The film was then carried through the reaction zone at a rate of 9.1 meter/min resulting in an approximate exposure time of 10 seconds. At the end of this treatment time, the RF power and the gas supply were stopped, and the chamber was returned to atmospheric pressure.

Step 4 (depositing the masking layer): A solution of 4 wt. % PVB solution in IPA (Coating Solution 1) was die coated in a roll-to-roll process onto the antibiofouling layer of the film from Step 3 with a slot die at a rate of 0.0254 m/s. The solution was coated 15.24 cm wide and pumped with a Harvard syringe pump at a rate of 3.6 SCCM. The coating was dried at room temperature for four minutes to create a PVB masking layer over the entire structured surface resulting in a substantially planar surface. As a result, the masking layer was significantly thinner on the tops of the posts as compared to the recessed regions between the posts.

Step 5 (removing the masking layer from the tops of the posts and creating the binding inorganic layer): Reactive ion etching was carried out on the masked film in the reactor chamber described above to create an etched film. After placing the masked film on the powered electrode, the reactor chamber was pumped down to a base pressure of less than 1.3 Pa. Oxygen gas was flowed into the chamber at a rate of 100 SCCM. RF power (13.56 MHz) was subsequently coupled into the reactor with an applied power of 7500 W. The film was then carried through the reaction zone at a rate of 3.7 m/min to achieve an exposure time of approximately 25 seconds. At the end of this treatment time, the RF power and the gas supply flow were stopped, and the chamber was returned to atmospheric pressure. This step removed the masking layer on the tops of the posts and converted the underlying methylated surface to an inorganic (SiOx) surface. The masking layer was not fully removed in the recessed regions between the posts, masking the underlying regions from the effects of the reactive ion etching process.

The structure resulting from Steps 1 to 5 corresponds to the structure of FIG. 1. As shown in FIG. 1, antibiofouling layer 180 is bonded to second major resin surface 112 in land areas 140. In the structure produced in this example, the antibiofouling layer also extends up the sides of the projections in the area where it is overlaid by the masking layer. As shown in FIG. 1, masking layer 160 is bonded to antibiofouling layer 180 with the exposed surfaces of the masking layer collectively forming recessed surface 165. Inorganic layer 150 is bonded to distal ends 131 of projections 130 with the exposed surfaces of the inorganic layer collectively forming projected surface 155. In the structure produced in this example, the inorganic layer also extends down the sides of projections, ending prior to reaching the recessed surface.

Step 6 (adding the lamination layer and the transfer carrier): A transfer carrier was laminated to the topside of the etched structured-surface created in Step 5 by feeding Acrylate Resin A into a nip just prior to the lamination of a 1.5 mil PET carrier film to the etched structured-surface. The acrylate adhesive resin was syringe fed into the nip to keep the coating 10-12 cm wide. The nip consisted of a 90-durometer rubber roll and a steel roll set at 54° C. The nip was engaged by two air cylinders pressed by 0.27 MPa. The films remain in contact for approximately 1.5 meters, while they were cured with a fusion D bulb.

Step 7 (removing the support film) Subsequent to the curing process of Step 6, the support film was peeled from the skin layer exposing the skin layer.

Step 8 (coating with adhesive): A solution of 6 wt. % of a block copolymer thermal adhesive (Kraton FG1901, A from Kraton Corporation) in toluene was die coated in a roll-to-roll process onto the exposed surface of the skin layer with a slot die at a rate of 0.0254 m/s. The solution was coated 15.24 cm wide and pumped with a Harvard syringe pump at a rate of 0.8 SCCM. The adhesive coating was dried at 65° C. for 4 minutes and a polypropylene liner was introduced at the winder.

Step 9 (laminating to glass): The film was cut to the size of a 100 mm diameter, 1 mm thick H-K9L glass wafer from University Wafer, (Boston, MA, USA). The polypropylene liner was then peeled from the adhesive and the final construction was placed on top of the wafer. The construction was then vacuum laminated to the wafer using a NILT CNI tool.

Step 10 (removing the transfer carrier and lamination layer): Following lamination to the wafer, the transfer carrier and lamination layer were peeled from the from the construction. In the process, the masking layer that remained in the recessed regions following Step 5 was removed exposing the antibiofouling layer deposited in Step 3. If any of the masking layer remained, it was washed off with an appropriate solvent, e.g., water, to expose the antibiofouling layer.

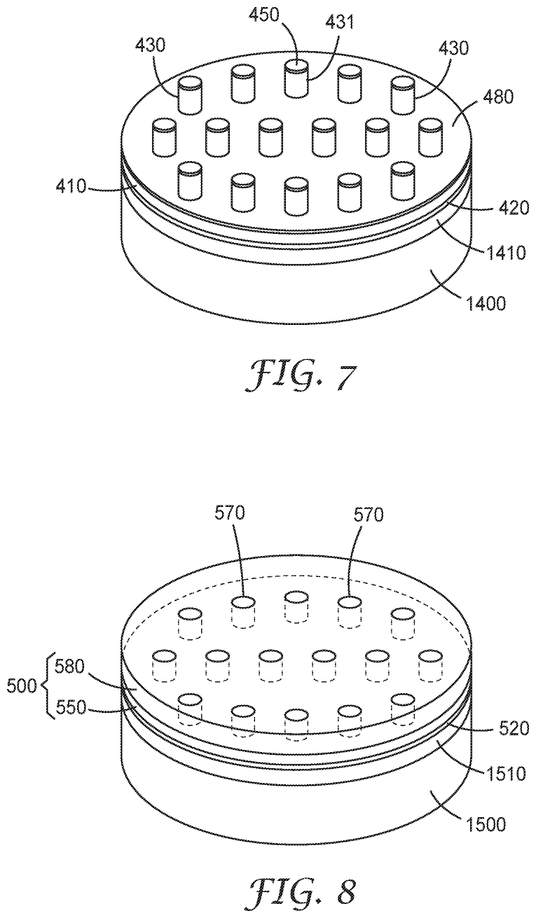

The resulting construction is shown in FIG. 7. Skin layer 420 is bonded to glass wafer 1400 by adhesive layer 1410. The structured substrate comprises resin layer 410, antibiofouling layer 480 and inorganic layer 450. Resin layer 410, which is bonded to skin layer 420, includes a plurality of projections 430, wherein each projection terminates in a distal end 431 and is separated from adjacent projections by land areas, which are not visible below the antibiofouling layer. Antibiofouling layer 480 is bonded to the resin layer in the land areas. In some cases, the antibiofouling layer may also cover at least a portion of the sides of the projections. Inorganic layer 450 is bonded to distal ends 431 of projections 430.

### Example 2: Wells

Step 1 (making a template film): A nano-featured template film was prepared by die coating Acrylate Resin B onto a polycarbonate film. The coated film was pressed against a nanostructured nickel surface attached to a steel roller controlled at 60° C. using a rubber covered roller at a speed of 15.2 meters/min. The nanostructured nickel tool consists of a 10 cm×10 cm patterned area with 1500 nm diameter hole features on a 3000 nm pitch. The coating thickness of Acrylate Resin B on the film was sufficient to fully wet the nickel surface and form a rolling bead of resin as the coated film was pressed against the nanostructured nickel surface. The film was exposed to radiation from two Fusion UV lamp systems (obtained under the trade designation “F600” from Fusion UV Systems, Gaithersburg, MD) fitted with D bulbs both operating at 142 W/cm while in contact with the nanostructured nickel surface. After peeling the template film from the nanostructured nickel surface, the nanostructured side of the template film was exposed again to radiation from the Fusion UV lamp system. The resulting post features formed in the acrylate resin layer were about 250 nm tall and had side wall angles of approximately 4 degrees.

Step 2 (release-treating the template film): A hexamethyldisiloxane (HMDSO) containing release film assembled according to methods described in U.S. Pat. No. 6,696,157 (David et al.) and U.S. Pat. No. 8,664,323 (Iyer et al.) and U.S. Patent Publication No. 2013/0229378 (Iyer et al.) was applied to the nano-featured template film from Step 2 in a parallel plate capacitively coupled plasma reactor. The chamber has a central cylindrical powered electrode with a surface area of 1.7 square meters.

After placing the nanostructured template film on the powered electrode, the reactor chamber was pumped down to a base pressure of less than 1.3 Pa. O₂ gas flowed into the chamber at a rate of 1000 SCCM. Treatment was carried out using a plasma enhanced CVD method by coupling RF power into the reactor at a frequency of 13.56 MHz and an applied power of 2000 watts. Treatment time was controlled by moving the nanostructured template film through the reaction zone at rate of 9.1 meter/min resulting in an approximate exposure time of 10 seconds. After completing the deposition, RF power was turned off and gases were evacuated from the reactor. Following the first treatment, a second plasma treatment was carried out in the same reactor without returning the chamber to atmospheric pressure. HMDSO gas was flowed into the chamber at approximately 1750 SCCM to achieve a pressure of 1.2 Pa. 13.56 MHz RF power was subsequently coupled into the reactor with an applied power of 1000 W. The film was then carried through the reaction zone at a rate of 9.1 meter/min resulting in an approximate exposure time of 10 seconds. At the end of this treatment time, the RF power and the gas supply were stopped, and the chamber was returned to atmospheric pressure.

Step 3 (making the skin layer): A 400 nm thick peelable acrylate skin layer was made on a PET support layer using the methods described in International Patent Application PCT/IB2022/061266 (“Planarized Inorganic Thin Film Transfer Article.”)

Step 4 (depositing the inorganic layer): A randomly nanostructured silicon containing etch resist (inorganic layer) was deposited onto the peelable acrylate layer made in Step 3 using a home-built parallel plate capacitively coupled plasma reactor as described in U.S. Pat. Nos. 6,696,157).

The chamber has a central cylindrical powered electrode with a surface area of 1.7 square meters. After placing the film on the powered electrode, the reactor chamber was pumped down to a base pressure of less than 1.3 Pa. O₂ and HMDSO gases flowed into the chamber at a rate 18 SCCM, and 750 SCCM respectively. Treatment was carried out using a plasma enhanced CVD method by coupling RF power into the reactor at a frequency of 13.56 MHz and an applied power of 7500 watts. Treatment time was controlled by moving the film through the reaction zone at rate of 6.7 meters/minutes, resulting in an approximate exposure time of 13 seconds. After completing the deposition, RF power was turned off and gases were evacuated from the reactor.

Following the first treatment, a second plasma treatment was carried out in the same reactor without returning the chamber to atmospheric pressure. Tetramethyl silane and O₂ gases were flowed into the chamber at approximately 500 SCCM and 2000 SCCM respectively. 13.56 MHz RF power was subsequently coupled into the reactor with an applied power of 2000 W. The film was then carried through the reaction zone at a rate of 9.1 meters/minute, resulting in an approximate exposure time of 10 seconds.

Following the second treatment, a third plasma treatment was carried out in the same reactor without returning the chamber to atmospheric pressure. O₂ gas flowed into the chamber at approximately 2000 SCCM. 13.56 MHz RF power was subsequently coupled into the reactor with an applied power of 2000 W. The film was then carried through the reaction zone at a rate of 9.1 meters/minute, resulting in an approximate exposure time of 10 seconds. At the end of this treatment time, the RF power and the gas supply were stopped, and the chamber was returned to atmospheric pressure.

Step 5 (coating of the antibiofouling layer): Fluoropolymer Solution 1 was die coated in a roll-to-roll process onto the inorganic (SiOx) surface of the substrate from Step 4 with a slot die at a rate of 0.0508 m/s. The solution was coated 15.24 cm wide and pumped with a Harvard syringe pump at a rate of 2.78 SCCM. The coating was dried at 65 degrees Celsius for 4 minutes.

Step 6 (adding the masking and pattern) The release-treated template film created in Step 2 was slot-die coated with Coating Solution 2 (PVA) at 0.0508 meters per second. Web tensions were set to be approximately 0.0057 N/mm. The PVA solution was coated 15.24 cm wide and pumped with a Harvard syringe pump at a rate of 5.8 SCCM. The coating was dried at 66° C. for 3 minutes. The coated film then entered a nip approximately 15 meters after coating. At the nip, the film prepared in Step 5 was laminated such that the antibiofouling layer contacted the PVA coated surface of the release-treated template film. The nip consisted of a 90-durometer rubber roll and a steel roll set at 76.7° C. The nip was engaged by two Bimba air cylinders pressed by 0.55 MPa. The resulting construction was peeled apart causing the PVA masking layer to separate from the HMDSO release surface. The resulting multilayer film consisted of the PET support layer, the peelable acrylate skin layer, the inorganic layer, the antibiofouling layer and a patterned masking layer comprising wells corresponding to the inverse of the posts of the template film.

Step 7 (re-exposing the inorganic layer): Reactive ion etching was carried out on the film from Step 6 in the same home-built reactor chamber used to deposit the PECVD release layer to create an etched film. After placing the coated film on the powered electrode, the reactor chamber was pumped down to a base pressure of less than 1.06 Pa. O₂ gas flowed into the chamber at a rate of 1000 SCCM. 13.56 MHz RF power was subsequently coupled into the reactor with an applied power of 4000 W. The film was then carried through the reaction zone at a rate of 4.6 meters/minute, to achieve an exposure time of approximately 20 sec. At the end of this treatment time, the RF power and the gas supply were stopped, and the chamber was returned to atmospheric pressure. This step removed both the masking layer and the antibiofouling layer to form the wells and expose the inorganic layer at the base of the wells. The masking layer was not fully removed in the regions over the antibiofouling layer in the land areas, masking the underlying regions from the effects of the reactive ion etching process.

The structure resulting from Steps 1 to 7 is similar to the structure shown in FIG. 2.

Step 8 (adding the lamination layer and the transfer carrier): A transfer carrier was laminated to the topside of the etched structured surface prepared in Step 7 by feeding Acrylate Resin A into a nip just prior to the lamination of a 1.5 mil PET carrier film. The acrylate adhesive resin was syringe fed into the nip so as to keep the coating 10-12 cm wide. The nip consisted of a 90-durometer rubber roll and a steel roll set at 54° C. The nip was engaged by two Bimba air cylinders pressed by 0.27 MPa. The films remain in contact for approximately 1.5 m, where they were cured with a fusion D bulb. Subsequently, the support film was peeled from the skin layer exposing the skin layer.

Step 9 (coating with adhesive): A solution of 6 wt. % of a block copolymer thermal adhesive (Kraton FG1901, A from Kraton Corporation) in toluene was die coated in a roll-to-roll process onto the exposed surface of the skin layer with a slot die at a rate of 0.0254 m/s. The solution was coated 15.24 cm wide and pumped with a Harvard syringe pump at a rate of 0.8 SCCM. The adhesive coating was dried at 65° C. for 4 minutes and a polypropylene liner was introduced at the winder.

Step 10 (laminating to a glass): The film was cut to the size of a 100 mm diameter, 1 mm thick H-K9L glass wafer from University Wafer, (Boston, MA, USA). The polypropylene liner was then peeled from the adhesive and the final construction was placed on top of the wafer. The construction was then vacuum laminated to the wafer using a NILT CNI tool.

Step 11 (removing the transfer carrier and lamination): Following lamination to the wafer, the transfer carrier and lamination layer were peeled from the construction, thereby removing the masking layer that remained on the land areas following Step 7, exposing the antibiofouling layer deposited in Step 5. If any of the masking layer remained, it was washed off with an appropriate solvent, e.g., water, to expose the antibiofouling layer.

The resulting construction is shown in FIG. 8. Skin layer 520 is bonded to glass wafer 1500 by adhesive layer 1510. Structured substrate 500 comprises inorganic layer 550 and antibiofouling layer 580. Inorganic layer 550 is bonded to skin layer 520. Antibiofouling layer 580 is bonded to inorganic layer 550 and includes a plurality of wells 570 that extend from the surface of the antibiofouling layer and terminate in an exposed portion of the inorganic layer.

Autofluorescence spectra were collected for (A) the 15-micron thick PETg skin layer of Example 1, (B) the 400 nm thick acrylate skin layer of Example 2, and (C) a 30-micron thick PET layer typical of prior art approaches. The samples were analyzed at three excitation wavelengths, and the resulting autofluorescence spectra were collected using a 5 nm band pass covering three emission wavelength ranges, as summarized in Table 3. The values reported in Table 2 are the peak autofluorescence emission intensity within each wavelength range. The 400 nm thick acrylate film was adhesively mounted to a borosilicate glass slide for handling. The autofluorescence of the combination of the acrylate film, adhesive and the glass, as well as the autofluorescence of the glass alone are reported in Table 3.

TABLE 2
Autofluorescence wavelength ranges.

| Emission | Excitation |
|---|---|
| Range | Wavelength |
| 380 to 675 nm | 365 nm |
| 580 to 857 nm | 532 nm |
| 699 to 952 nm | 642 nm |

TABLE 3
Peak autofluorescence data.

| | | Example 2 | | |
|---|---|---|---|---|
| | Example 1 | 400 nm | | |
| Emission | 15 um | acrylate | Borosilicate | Comparative |
| Range | PETg | with glass | glass | 30 um PET |
| 380 to 675 nm | 1.3E+06 | 1.3E+05 | 1.0E+05 | 2.2E+07 |
| 580 to 857 nm | 7.8E+04 | 8.6E+04 | 8.0E+04 | 4.6E+05 |
| 699 to 952 nm | 1.2E+05 | 3.1E+04 | 3.2E+04 | 9.7E+05 |

1. An article comprising
a skin layer having a first major skin surface and a second major skin surface;
a structured substrate having a planar major surface adjacent the second major skin surface and a structured surface comprising a projected surface and a recessed surface; wherein the structured substrate comprises an antibiofouling layer, an inorganic layer and a masking layer; and
a transfer carrier comprising a lamination layer having a first lamination surface bonded to the projected surface and the recessed surface, wherein
the inorganic layer has a first major inorganic surface bonded to the second major skin surface,
the antibiofouling layer has a first major antibiofouling surface bonded to a second major inorganic surface of the inorganic layer and a second major antibiofouling surface, wherein the antibiofouling layer further comprises a plurality of wells extending from the second antibiofouling surface through a thickness of the antibiofouling layer, each well terminating in an exposed portion of the second major inorganic surface of the inorganic layer, wherein the exposed portions collectively form the recessed surface, and
the masking layer bonded to the second major antibiofouling surface forming the projected surface;
wherein a second lamination surface is bonded to the masking layer and to the exposed portions of second major inorganic surface in the wells.

2. An article comprising
a skin layer having a first major skin surface and a second major skin surface;
a structured substrate having a planar major surface adjacent the second major skin surface and a structured surface comprising a projected surface and a recessed surface; wherein the structured substrate comprises an antibiofouling layer, an inorganic layer and a masking layer; and
a transfer carrier comprising a lamination layer having a first lamination surface bonded to the projected surface and the recessed surface, wherein the structured substrate further comprises a resin layer having a first major resin surface bonded to the second major skin surface and a plurality of projections, wherein each projection terminates in a distal end at a second major resin surface and is separated from adjacent projections by land areas of the second major resin surface, wherein
the inorganic layer is bonded to the distal ends of the projections collectively forming the projected surface,
the antibiofouling layer is bonded to the second major resin surface in the land areas, the masking layer is bonded to the antibiofouling layer in the land areas forming the recessed surface, and a second lamination surface is bonded to the inorganic layer at the distal ends of the projections and to the masking layer in the land areas.

3. The article of claim 2, wherein the resin layer comprises at least one of cyclic olefin copolymers, biaxially oriented polypropylenes, polyacrylates, polymethacrylates, and copolymers of acrylates and methacrylates.

4. The article of claim 1, wherein the masking layer comprises a water-soluble polymer.

5. The article of claim 1, wherein the masking layer is selected from the group consisting of polyvinyl alcohol, polyvinyl butyral and combinations thereof.

6. The article of claim 1, wherein the antibiofouling layer comprises a methyl-terminated surface.

7. The article of claim 1, wherein the antibiofouling layer comprises a fluoropolymer.

8. The article of claim 1, wherein the inorganic layer comprises an oxide of silicon, titanium, aluminum, and combinations thereof.

9. (canceled)

10. The article of claim 1, wherein the skin layer is 5 nm to 15 microns thick, inclusive.

11. The article of claim 10, wherein the skin layer is 5 nm to 500 nm thick, inclusive.

12. The article of claim 1, wherein the skin layer comprises at least one of polyesters, cyclic olefin polymers, cyclic olefin copolymers, polyacrylates, polycarbonates, and polymethacrylates.

13. The article of claim 1 further comprising a support layer comprising a polymeric film releasably attached to the first major skin surface of the skin layer.

14. The article of claim 1 further comprising an adhesive layer bonded to the first major skin surface of the skin layer.

15. The article of claim 14 further comprising a rigid substrate bonded to the adhesive layer, opposite the skin layer.

16. The article of claim 15, wherein the rigid substrate comprises at least one of glass and silicon.

17. A method comprising
on a support structure comprising a support layer and skin layer having a first major skin surface bonded to the support layer, creating a structured substrate having a planar major surface bonded to a second major skin surface of the skin layer and a structured surface comprising a projected surface, a recessed surface, and a side surface connecting the projected surface and the recessed surfaces, wherein the structured substrate comprises an antibiofouling layer, an inorganic layer and a masking layer;
bonding a transfer carrier comprising a lamination layer to the projected surface and the recessed surface, wherein at least a portion of the lamination layer is bonded to the masking layer; and
separating the skin layer from the support layer, wherein the transfer carrier and structured substrate remain bonded to the skin layer forming a transferable structured substrate;
wherein,
the inorganic layer has a first major inorganic surface bonded to the second major skin surface,
the antibiofouling layer has a first major antibiofouling surface bonded to a second major inorganic surface of the inorganic layer and a second major antibiofouling surface, wherein the antibiofouling layer further comprises a plurality of wells extending from the second antibiofouling surface through a thickness of the antibiofouling layer, each well terminating in an exposed portion of the second major inorganic surface of the inorganic layer, wherein the exposed portions collectively form the recessed surface, and
the masking layer bonded to the second major antibiofouling surface forming the projected surface;
wherein a second lamination surface is bonded to the masking layer and to the exposed portions of second major inorganic surface in the wells.

18. (canceled)

19. The method of claim 17 further comprising applying an adhesive layer to the first major skin surface of the skin layer of the transferable structured substrate.

20. The method of claim 19 further comprising bonding the transferable structured substrate to a rigid substrate.

21. The method of claim 17, further comprising separating the transfer carrier from the structured surface.

22. The method of claim 21, wherein at least a portion of the masking layer is removed while separating the transfer carrier from the structured surface.
